(19) United States
(12) Patent Application Publication
(10) Pub. No.: US 2007/0294026 A1
(43) Pub. Date: Dec. 20, 2007

(54) ROUTE DETERMINATION SYSTEM FOR A HYBRID VEHICLE

(75) Inventor: Hartmut Schirmer, Pinneberg (DE)

Correspondence Address: THE ECLIPSE GROUP, 10605 BALBOA BLVD., SUITE 300, GRANADA HILLS, CA, 91344, US

(73) Assignee: Harman Becker Automotive Systems GmbH, Karlsbad (DE)

(21) Appl. No.: 11/692,876

(22) Filed: Mar. 28, 2007

(30) Foreign Application Priority Data
Apr. 3, 2006 (EP) 06 007 048.9

(51) Int. Cl. G01C 21/32; G06F 19/00

(52) U.S. Cl. 701/202; 701/209; 340/995.19

(57) ABSTRACT

Route determination systems and methods are provided for determining a route for a hybrid vehicle having at least two different mechanisms for driving the vehicle. One example of a method includes determining the resource status of at least one of the at least two different driving mechanisms, determining a destination location for the vehicle, and determining a route to the predetermined destination location. The uses of the different driving mechanisms may be determined in accordance with the determined resource status.

### RELATED APPLICATIONS

This application claims priority of European Patent Application Serial Number 06 007 048.9 filed Apr. 3, 2006, titled ROUTE DETERMINATION FOR A HYBRID VEHICLE AND SYSTEM THEREFORE; which is incorporated by reference in this application in its entirety.

### BACKGROUND OF THE INVENTION

1. Field of the Invention

This invention relates generally to hybrid vehicles and more particularly to systems and methods for controlling a hybrid vehicle.

2. Related Art

Hybrid vehicles are vehicles powered by two different forms of energy. As such, hybrid vehicles employ two different driving mechanisms. One driving mechanism is typically a internal combustion engine and the other driving mechanism is a motor powered by some other form of energy. In some hybrid vehicles, fuel cells or gas motors may be used as the second driving mechanism. However, electric hybrid vehicles (hybrid vehicles in which the second drive mechanism is an electric motor) have drawn attention as a practical and cost-effective solution to reducing fuel consumption.

In an electric hybrid vehicle, the internal combustion engine is a typical gasoline-based engine variant of engines used in typical automobiles. The electric hybrid vehicle also includes an electric motor, a battery pack to store electrical energy used by the electric motor, and a regenerative breaking system to capture the energy that is normally lost when the driver applies the brakes. During operation, electric hybrid vehicles may be using the gasoline engine, the electric motor, or both as the active driving mechanisms.

Improvements have been made to electric hybrid vehicles to further help reduce fuel consumption. In one example, the different driving mechanisms are controlled in accordance with a known route to be followed by the vehicle to a predetermined destination. The driving mechanisms are controlled in a way that minimizes fuel consumption. In one particular example, an onboard navigation system provides an energy management function in a hybrid electric vehicle. The known route may be analyzed to determine whether it includes locations for recharging the battery pack, such as passages that are downhill, or stretches of stop and go traffic. The known route may also be analyzed to determine expectations of the driver demand and the use of the different driving mechanisms can be controlled accordingly.

Another example involves controlling an electric hybrid vehicle in which a rechargeable battery is discharged and recharged with regenerative braking. The discharge of the battery and therefore the use of the electric motor is controlled in accordance with the characteristics of the upcoming route.

These example systems determine a route first and then control the use of the different driving mechanisms for the determined route. However, these systems do not take into account the present resource status of the vehicle. By way of example, depending on the present resource status of the vehicle, there may exist different optimum routes to a predetermined destination. For hybrid vehicles the resource status is an important factor for at least some of the driving mechanisms. For some of the driving mechanisms, such as the gasoline engine, it may be easy to refill the resources (e.g. at a gasoline station), however, for other driving mechanisms such as a gas-based engine or an electric motor how much energy resources a motor has is a crucial factor for the determination of which route should be taken and which driving mechanism should be used for the route. Accordingly, a need exists for a system capable of adapting route calculation to the current operating status of a vehicle.

### SUMMARY

In view of the above, a method consistent with the present invention includes determining a route for a hybrid vehicle having at least two different mechanisms for driving the vehicle. A resource status may be determined for at least one of the at least two different driving mechanisms. The method may also include determining a destination location for the vehicle, as well as a route to the destination location. A use of the different driving mechanisms for the route may then be determined in accordance with the resource status.

A system for controlling the hybrid vehicle consistent with the present invention includes a resource determination unit for determining the resource status of at least one of the at least two different driving mechanisms; a position detecting unit; a route determination unit for determining the route to a predetermined destination location; and a driving mechanism control unit for determining the use of the different driving mechanisms and for determining switching locations for changing the driving mechanism for the route in accordance with the determined resource status.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

Examples of systems and methods consistent with the present invention are described below with reference to the following figures. The components in the figures are not necessarily to scale, emphasis instead being placed upon illustrating the principles of the invention. In the figures, like reference numerals designate corresponding parts throughout the different views.

FIG. 1 is a block diagram of an example of a system for controlling a hybrid vehicle.

FIG. 2 is a flow chart depicting an example method for controlling the route determination and the use of the driving mechanisms in view of the resource status.

FIG. 3 is a diagram of an example of a part of a route that includes driving constraints.

FIG. 4 is a flow chart of another example for determining a route for a hybrid vehicle and for determining the use of the different driving mechanisms.

FIG. 5 is a flow chart of another example for determining a route for a hybrid vehicle and for determining the use of the different driving mechanisms.

### DETAILED DESCRIPTION

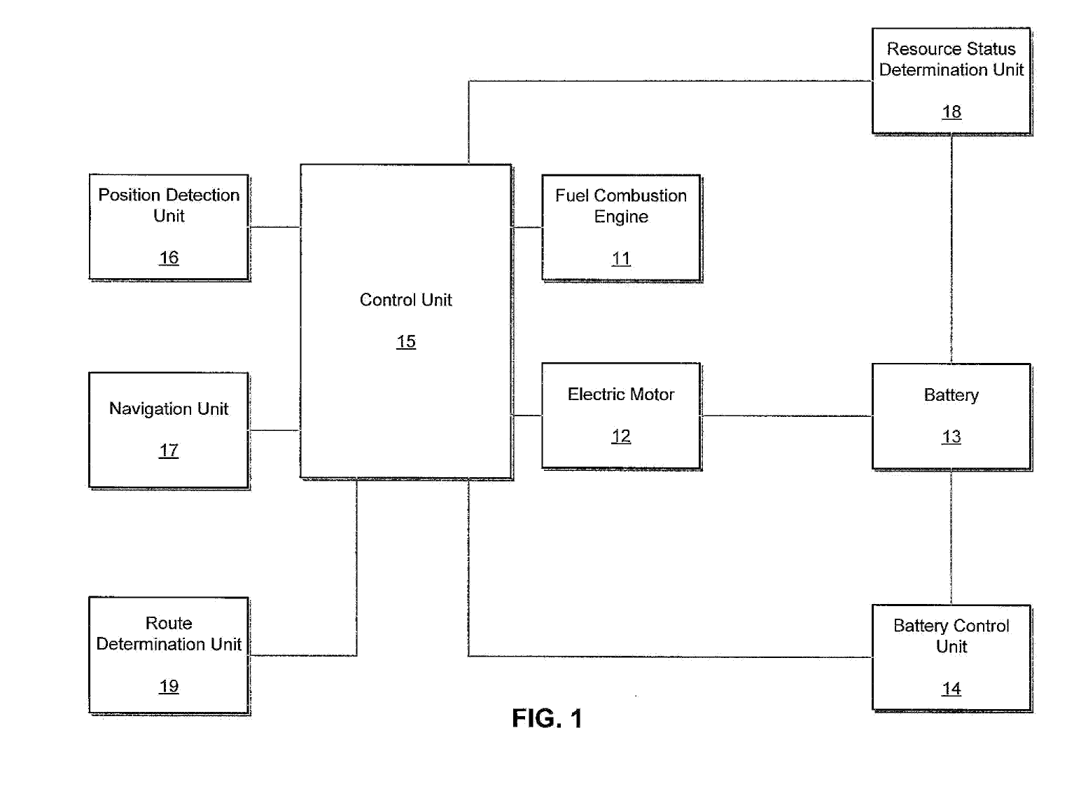

FIG. 1 is a block diagram of an example of a system for controlling a hybrid vehicle. The hybrid vehicle includes a first driving mechanism, such as a fuel combustion engine 11, and a second driving mechanism, such as an electric motor 12. Those of ordinary skill in the art will appreciate that the example systems and methods for controlling the hybrid vehicle described in this application may be used with any suitable hybrid vehicle. The electric motor 12 may be powered by a battery 13, which may be recharged during driving, e.g., when the brake of the vehicle is activated, or when the fuel combustion engine 11 is the driving mechanism driving the vehicle. The recharging and discharging of the battery 13 may be controlled by a battery control unit 14. A resource determination unit 18 may be included to determine the resource status of the driving mechanism. An example of a resource status may be the battery charge level of the battery 13.

The system may also include a main control unit 15, which may provide control for the coupling of the fuel combustion engine 11 or the electric motor 12 to the drive wheels via a shaft not shown in FIG. 1. The main control unit 15 may also couple both driving mechanisms 11 and 12 to the drive wheels. This may occur in acceleration situations where the use of both the fuel combustion engine 11 and the electric motor 12 can improve the acceleration of the vehicle.

The system may also include a position detection unit 16 for detecting the actual position of the vehicle. In the example shown in FIG. 1, the position detection unit 16 can detect the actual vehicle position using data based on a Global Positioning System (GPS), although other dead reckoning systems that take into account other sensor signals of the vehicle may be used as well. In addition to the position detection unit 16, a navigation unit 17 may be provided for calculating a route to a predetermined destination location. In one example, the navigation unit 17 may base its calculation on digital map data (not shown in FIG. 1). The navigation system 17 may be of a type that is conventional and known to persons of ordinary skill in the art, so that a detailed functional description of the navigation unit 17 is unnecessary. The route determination unit 19 may be included for determining the route to a predetermined destination location using the resource status as an input parameter (via the control unit 15, for example). Those skilled in the art will also recognize that the navigation unit 17 and the route determination unit 19 may be a single unit, which may be referred to as a single determination unit 19. The control unit 15 may operate with the position detection unit 16, the navigation unit 17, the resource determination unit 18 and/or the route determination unit 19 to control the use, or selection of the driving mechanisms. The control unit 15 may also determine switching locations for changing the driving mechanisms for the route in accordance with the resource status.

The example system shown in FIG. 1 may be used to control a hybrid vehicle by determining an optimized route to a destination in accordance with the status of a resource used by one or more of its driving mechanisms. In the example in FIG. 1, one example resource status is the charge remaining in the battery 13 that powers the electric motor 12. Once the resource status and the destination location are known, the driving mechanism to be used for the different parts of the route may be determined in advance. The resource status may be used to determine the use or selection of the driving mechanisms at determined parts of the route, or the route may be determined in accordance with the resource status at determined parts of the route. In addition, the switching point from one driving mechanism to the other driving mechanism or from one driving mechanism to both driving mechanisms or from both driving mechanisms to one driving mechanism may also be determined for the route.

In other examples of the system of FIG. 1, the driving mechanisms may be controlled in such a way that during driving, the driving mechanisms are switched at predetermined switching points. For example, the switching points and the selection of the different driving mechanisms may be determined such that, when an internal combustion engine is utilized as one driving mechanisms, fuel consumption is minimized. The driving mechanisms may be a gasoline engine, a diesel engine, a gas engine, an electric motor or a hydrogen driven motor. It should be understood that these driving mechanisms are listed for purposes of providing examples and that other driving mechanisms may be utilized.

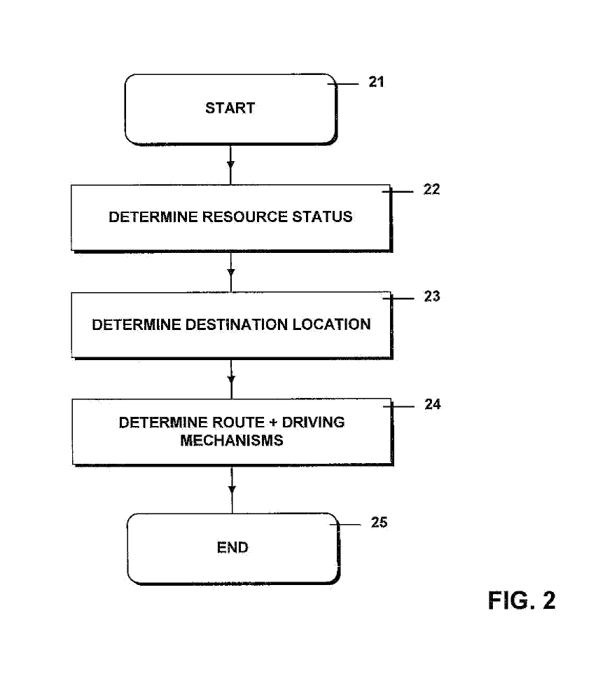

FIG. 2 is a flow chart depicting an example method for controlling the route determination and the use of the driving mechanisms in view of the resource status. The process may be started at step 21 at some point before or during the initiation of a drive of the hybrid vehicle to a destination. At step 22, the resource status for at least one of the driving mechanisms is determined. This may include determining the resource status for the driving mechanism for which refilling or recharging mechanisms are less common. In an example using a system such as the one shown in FIG. 1, step 22 includes determining the resource status of the electric motor, or the driving mechanism that is not a gasoline or diesel motor, although the resource status of all driving mechanisms may be determined.

At step 23, the destination is determined. Once the resource status and the destination location have been determined, a route and the use of the different driving mechanisms for the route may be determined at step 24. The route and use of driving mechanisms may take the resource status into account. The driving mechanisms may be controlled in such a way that the fuel consumption of the fuel combustion engine 11 (FIG. 1) is minimized. In addition, other information about the route such as altitude change, road pattern or driving patterns of the driver may be considered for determining the route and the use of the different driving mechanisms for the different parts of the route. In one example, when the fill status of the battery 13 (FIG. 1) is low and there are two possible routes in order to arrive at the destination location, a first route having a negative elevation gradient at the beginning may be selected over a second route having a positive elevation gradient to provide for recharging of the battery 13.

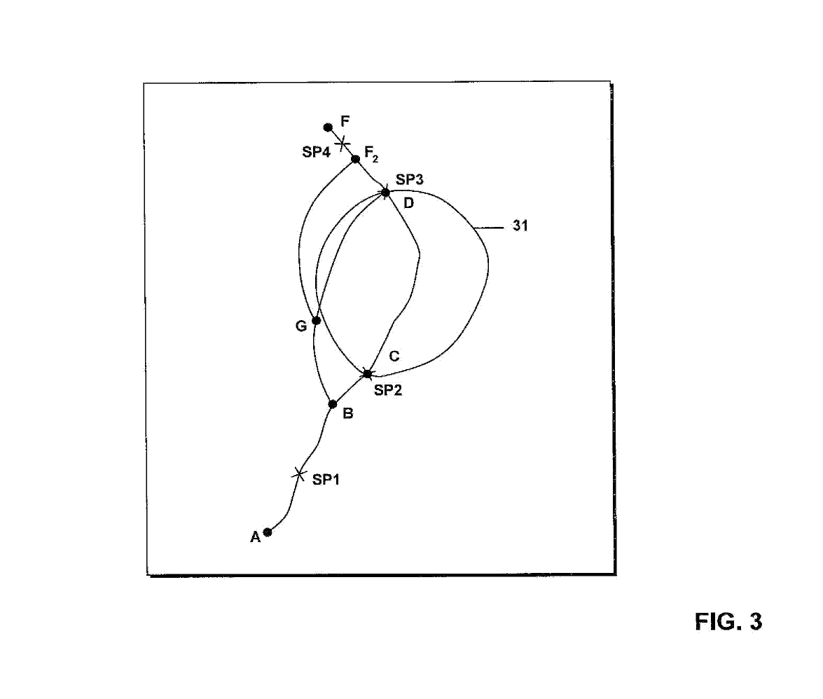

FIG. 3 is a diagram of an example of a part of a route that includes driving constraints The diagram includes a part of a map showing a route from a starting location A to a destination location F. Between location A and location F are locations B, C, D, E, F, and G. The fastest route from location A to location F may be the route traveling along points ABCDEF on the map. The map may show that the route includes a driving mechanism constraint as shown by encircled part 31. By way of example, this encircled part 31 of the map may be a downtown area for which a smog alarm has been activated, or for which the use of a fuel combustion engine 11 is completely prohibited. Accordingly, when the driver is using a hybrid vehicle having a fuel combustion engine 11 and an electric motor 12, the only driving mechanism that can be used within the encircled part 31 is the electric motor 12. If driving mechanism constraints for calculating the route from A to F are included, the controller (such as the control unit 15 in FIG. 1) may control a navigation unit (such as the navigation unit 17 in FIG. 1) in such a way that, if possible, the energy level of the battery 13 (FIG. 1) is high enough when the hybrid vehicle reaches location C for the vehicle to cross the encircled part 31 from location C to location D. It may not however be possible in view of the determined energy status of the battery 13 to drive from location C to location D using only the electric motor 12 (FIG. 1). If it is not possible, the system may determine the route in such a way that the vehicle travels along locations A, B, G, D, E, and F. If the resource status of the battery 13 is so low that use of the electric motor 12 is not allowed at all, the route may be determined in such a way that the encircled part 31 completely avoided, by selecting, for example, route A, B, G, E, and F.

The driving mechanism constraint in the encircled part 31 may not necessarily be a constraint. In one example, the user may set a preference indicating a desire to use one of the driving mechanisms in the encircled part 31. If such a preference is set, the control unit 15 may also control the different driving mechanisms such that the desired driving mechanism is used to traverse the encircled part 31.

The battery control unit 14 (FIG. 1) may also control selection of the route so that the battery 13 is recharged during selected parts of the route. For example, if there is a constraint precluding the use of a fuel combustion engine 11 within encircled part 31, the fuel combustion engine 11 may be used for the first part of the route from A to C. At the same time, the battery control unit 14 (FIG. 1) may ensure that the battery 13 is recharged to allow the vehicle to cross the encircled part 31 using only the electric motor 12. In addition, if this is not possible, then a detour over location B, G and E may be selected.

In one example, the vehicle may receive the driving mechanism constraint via a radio (or other wireless) receiver. For example, information about the driving mechanism constraint may be received for a predetermined geographical region may be included in data received in a traffic message channel. In this example, the system may react by determining the resource status at a present location, such as for example somewhere between locations A and B. The system may then determine a route and use of the driving mechanisms accordingly. If enough battery power is available at location C to be able to cross the encircled part 31, the navigation unit 17 (FIG. 1) may continue guiding the driver through locations B, C, D and E. If it is determined that there is not enough battery power at location C, the navigation unit 17 may change the route by directing the vehicle through locations B, G and D or E.

In addition to determining the route itself, the system may control which driving mechanism is being used for which part of the route. For example, when determining the route, the system may determine switching points, or locations at which the driving mechanism is changed. In one example, when traveling from location A to destination location F, the vehicle may be controlled in such a way that, starting from location A to a switching point SP1, the electric motor 12 is the driving mechanism used to drive the vehicle. At location SP1, the driving mechanism may be changed to the fuel combustion engine for travel between the locations SP1 and SP2. The control unit 15 may know that between SP2 and SP3, there may be a preference or constraint specifying the use of the electric motor 12. Accordingly, before entering geographical region 31, the vehicle may be driven using the fuel combustion engine 11, so that the battery 13 may be charged; such as by regenerative breaking or by the use of the fuel combustion engine itself. Between locations SP2 and SP3, the vehicle is driven by the electric motor. At location SP3, the driving mechanism may again be switched to the fuel combustion engine 11. At switching point SP4, the driving mechanism may be again switched to the electric motor 12, as the route indicates that the destination location will be reached at location F. If location F is known to include a location where the battery 13 may be recharged, the switching points may be determined such that the battery 13 can be discharged to a minimum level before reaching location F.

When the resource status and the route to the predetermined destination location is known, it is also possible to predict the resource status of the different driving mechanisms along the route. The switching points described above may initially be determined in connection with route determination before driving the route. During the process of driving, the system may verify whether the actual resource status corresponds to the predicted resource status. If the actual resource status does not correspond to the predicted resource status, the system may adjust accordingly and change the switching points taking into account the newly determined resource (e.g. the battery charge) status. The vehicle may then continue the remainder of the route with adjustments to the switching points, or to the route itself.

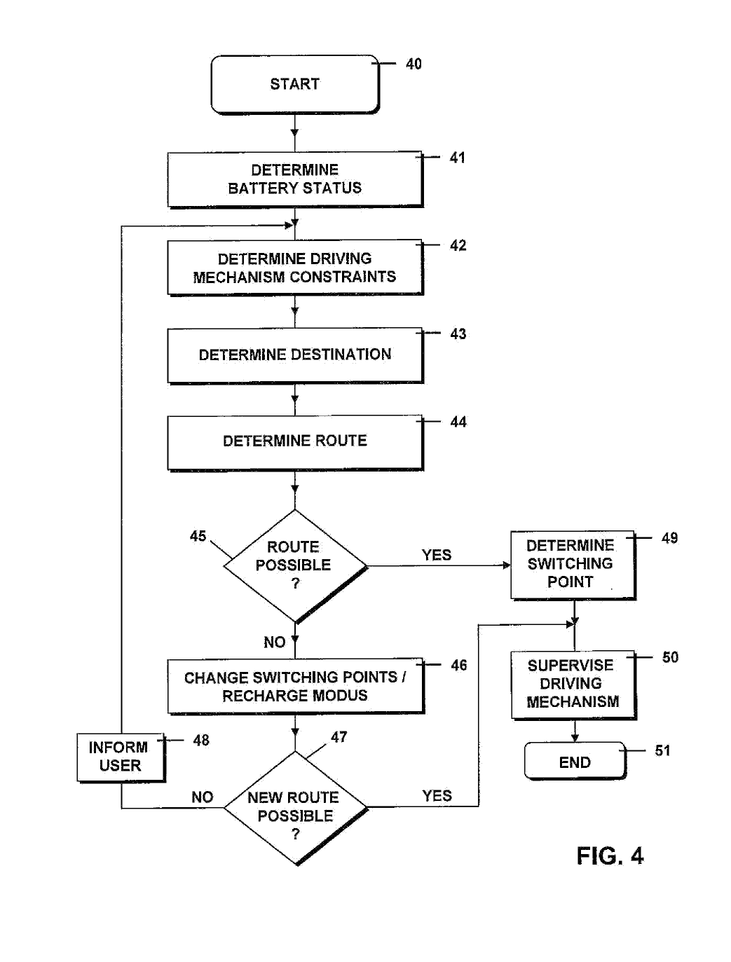

FIG. 4 is a flow chart of another example for determining a route for a hybrid vehicle and for determining the different driving mechanisms. FIG. 4 includes examples of steps that may be performed when a driving mechanism constraint is known. The process may begin at step 40 for a hybrid vehicle having a gas combustible engine 11 and an electric motor 12, for example. For determining the route, the battery 13 status may be determined at step 41. The driving mechanism constraints may also be determined at step 42. Before the route is calculated, a destination for which a route is to be calculated may be determined at step 43. When the battery 13 status and the driving mechanism constraints are known, the route to the predetermined destination may be calculated at step 44. As described with reference to FIG. 3, the system of the hybrid vehicle may now determine whether the battery status at location B will allow the vehicle to travel through encircled part 31. At decision point 45, the system checks whether it is possible to calculate any route meeting the driving mechanism constraints. If no route meeting the driving mechanism constraints in view of the determined battery 13 status may be calculated, the system may change any determined switching points in such a way that the battery 13 status will allow the crossing of an area having constraints only based on the electric motor 12 as shown at step 46. At decision point 47, the system then determines whether it is now possible to calculate a new route meeting the driving mechanism constraints. If it is again not possible, the system may inform the user at step 48 and restart to calculate a new route that may completely avoid the area where driving constraints exist.

If it was determined at decision point 45 that a route meeting the driving mechanism constraints in view of the determined battery 13 status may be calculated, at least one switching point may be determined and the vehicle may be guided along a proposed route at step 49. During driving, the battery 13 status may be verified at step 50. For example, the system may determine whether the current battery status, depending on the position, corresponds to a predicted battery status. If this is not the case, the system may recalculate the switching points in view of the actual battery status. If a route meeting the driving mechanism constraints could be calculated at step 47 after changing the switching points, the system also continues supervising the driving mechanism during driving.

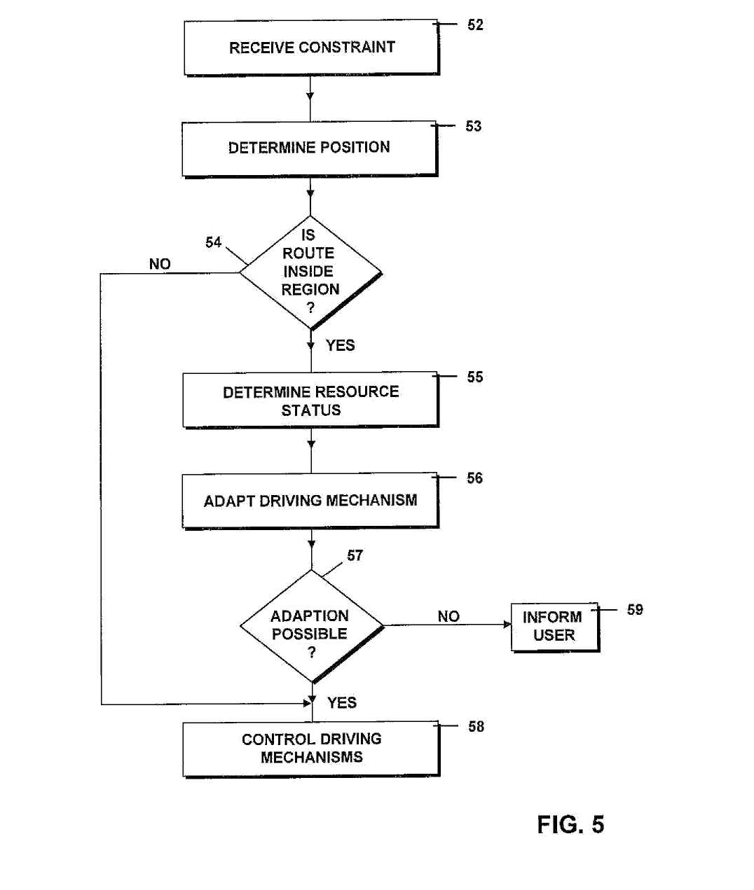

FIG. 5 is a flow chart of another example for determining a route for a hybrid vehicle and for determining the use of different driving mechanisms. FIG. 5 depicts an example in which a vehicle receives a driving mechanism constraint while driving along a route. For example, the driving mechanism constraints may be received using telecommunication networks and may be incorporated in a message received via a telecommunication unit of the vehicle. Furthermore, the driving mechanism constraint may also be received in connection with a radio program. Such a driving mechanism constraint may be received at step 52. The position of the vehicle may then be determined at step 53. At decision point 54, the system determines whether the actual position of the vehicle is inside the region in which the constraint applies. Additionally, at decision point 54, the system may determine whether a route to the destination will even cross the region for which the constraint applies. If the vehicle is inside the region or if the predicted route will pass the region for which the driving constraint exists, the system determines the resource status at step 55. At step 56, the driving mechanism may be adapted in such a way that the constraint will be met for the condition in which the vehicle is already inside the region having the constraint (or the route will pass the region). The driving mechanisms may then be controlled so that the driving mechanism meeting the constraint will have enough resources to drive the vehicle through the region. At decision point 57, the system determines whether the driving mechanism can be adapted in view of the new constraint situation. If the driving mechanism may be adapted in view of the new constraint situation, the driving mechanisms will be controlled accordingly at step 58. If the driving mechanism may not be adapted in view of the new constraint situation, the user may be informed at step 59 that, with the present route and the present resource status, the driving mechanism constraint can probably not be met. In one example, the driver may be informed after receiving the driving mechanism constraint at step 52, so that the driver knows that a change of the driving mechanisms might be necessary and that the energy control unit 15 (FIG. 1) changes the driving mechanisms accordingly.

It is to be understood that examples of systems and methods that include driving mechanism constraints are not limited to the types of constraints and/or preferences described. For example, the driving mechanism constraints may also depend on time. It may be possible that the vehicle is operating in conditions that include heavy smog. In such conditions, a responsible authority may determine that certain driving mechanisms are not allowed for predetermined geographical regions. In this example, driving mechanism constraints may be received using a wireless communication system. If such a constraint is received for a predetermined geographical region, the actual position of the vehicle may be determined and the user of the vehicle may be informed of the new driving mechanism constraints. It is also possible that when the driving mechanism constraints are known, the driving mechanism is automatically determined in such a way that the driving mechanism constraints are met. It should be understood that the above-described example also applies to driving mechanism preferences input by the user. When the user has determined in advance that in a certain geographical region a certain driving mechanism should be used, the user can either be informed that now the preferred driving mechanism should be selected, or the respective driving mechanism can also be selected automatically.

In examples that include predicting the resource status and predicting the switching locations, or switching points, it is also possible to consider known driving patterns of the driver. For example, the driver may be a person who normally drives in a very resource-saving way. This may mean that the driver does not normally accelerate too fast and may change velocity in a rather soft way. There also may be in contrast other drivers that normally accelerate very fast and which drive in a less resource-saving way. It is possible to consider known driving patterns of the driver that might have been recorded during driving. The extent to which the driver is driving to use driving resource in a resource-saving way may influence the prediction of the driving resources for the different parts of the route. Accordingly, driving patterns of the driver may be determined and these driving patterns may be used for predicting the use of the different driving mechanisms for the different parts of the route. Whether the driver is driving in a resource-saving way may be deemed a driving mechanism constraint. The driving mechanism status and the switching location may then be adapted to factor whether the driver uses a resource-saving way of driving. This may improve the accuracy of the prediction of the resource status and the switching locations. The driving mechanism pattern may be determined by taking former routes of the driver into account. If the vehicle has used the same route several times, the system may know how the driver normally drives. Additionally, it is possible to consider any other routes the driver has used before to determine the driving behavior of the driver.

In other examples, regenerative braking energy may depend on how often the brake is activated and for how long the brake is activated. Accordingly, the use of an electric motor in a hybrid vehicle may also depend on the traffic situation. In one example, the system may receive the traffic information and determine the use of the driving mechanism based on the traffic information. By way of example, on highways having little traffic, the electric motor may be used less often than on a crowded highway on which the vehicle is moving with stop and go. This traffic information may then be used for determining the route and the use of the different driving mechanisms.

The system may also include preset conditions that may be considered when a route is calculated. Such preset conditions may include user-selectable conditions. For example, the user may select the fastest route, the cheapest route, the route avoiding toll roads, highways, surface roads, etc. When the route to the predetermined destination location is calculated taking into account the resource status, a preset condition may be determined as another variable, the route being calculated additionally taking into account the preset condition, such as fastest route, shortest route, etc.

The foregoing description of an implementation has been presented for purposes of illustration and description. It is not exhaustive and does not limit the claimed inventions to the precise form disclosed. Modifications and variations are possible in light of the above description or may be acquired from practicing the invention. For example, persons skilled in the art will understand and appreciate, that one or more processes, sub-processes, or process steps described in connection with FIGS. 1 through 5 may be performed by hardware and/or software. Additionally, a route determination system, as described above, may be implemented completely in software that would be executed within a processor or plurality of processor in a networked environment. Examples of a processor include but are not limited to microprocessor, general purpose processor, combination of processors, DSP, any logic or decision processing unit regardless of method of operation, instructions execution/system/apparatus/device and/or ASIC. If the process is performed by software, the software may reside in software memory (not shown) in the device used to execute the software. The software in software memory may include an ordered listing of executable instructions for implementing logical functions (i.e., “logic” that may be implemented either in digital form such as digital circuitry or source code or optical circuitry or chemical or biochemical in analog form such as analog circuitry or an analog source such an analog electrical, sound or video signal), and may selectively be embodied in any signal-bearing (such as a machine-readable and/or computer-readable) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “machine-readable medium,” “computer-readable medium,” and/or “signal-bearing medium” (herein known as a “signal-bearing medium”) is any means that may contain, store, communicate, propagate, or transport the program for use by or in connection with the instruction execution system, apparatus, or device. The signal-bearing medium may selectively be, for example but not limited to, an electronic, magnetic, optical, electromagnetic, infrared, or semiconductor system, apparatus, device, air, water, or propagation medium. More specific examples, but nonetheless a non-exhaustive list, of computer-readable media would include the following: an electrical connection (electronic) having one or more wires; a portable computer diskette (magnetic); a RAM (electronic); a read-only memory “ROM” (electronic); an erasable programmable read-only memory (EPROM or Flash memory) (electronic); an optical fiber (optical); and a portable compact disc read-only memory “CDROM” “DVD” (optical). Note that the computer-readable medium may even be paper or another suitable medium upon which the program is printed, as the program can be electronically captured, via, for instance, optical scanning of the paper or other medium, then compiled, interpreted or otherwise processed in a suitable manner if necessary, and then stored in a computer memory. Additionally, it is appreciated by those skilled in the art that a signal-bearing medium may include carrier wave signals on propagated signals in telecommunication and/or network distributed systems. These propagated signals may be computer (i.e., machine) data signals embodied in the carrier wave signal. The computer/machine data signals may include data or software that is transported or interacts with the carrier wave signal. Note also that the implementation may vary between systems. The claims and their equivalents define the scope of the invention.

What is claimed is:

1. A method for determining a route for a hybrid vehicle, the hybrid vehicle having at least two different mechanisms for driving the vehicle, the method comprising:
determining a resource status of at least one of the at least two different driving mechanisms;
determining a destination location for the vehicle;
determining a route to the predetermined destination location; and
determining a use of the different driving mechanisms for the route in accordance with the determined resource status.

2. The method of claim 1 where the step of determining the use of the different driving mechanisms includes the step of determining which driving mechanism is used for the different parts of the route.

3. The method of claim 1 where the step of determining the use of the different driving mechanisms includes the step of determining at least one switch location for changing the driving mechanism.

4. The method of claim 1 where the driving mechanisms are selected from the following mechanisms: gasoline, diesel, gas engine, electric motor, or hydrogen driven motor.

5. The method of claim 1 where the step of determining the resource status includes determining the resource status for a non-fossil fuel combusting driving mechanism.

6. The method of claim 1 where one driving mechanism is an electric motor and the step of determining the resource status includes the step of determining a charge status of a battery that stores the electric energy for the electric motor.

7. The method of claim 1 further comprising the step of:
determining at least one driving mechanism preference for at least one geographical region where the step of determining the route to the predetermined destination includes a step of accounting for the driving mechanism preferences, and the step of determining the use of the different driving mechanisms includes a step of accounting for the driving mechanism preferences.

8. The method of claim 7 where the driving constraints are received via a wireless communication unit.

9. The method of claim 1 further comprising:
determining at least one driving mechanism constraint for at least one geographical region where the step of determining the route to the predetermined destination includes a step of accounting for the driving mechanism constraints, and the step of determining the use of the different driving mechanisms includes a step of accounting for the driving mechanism constraints.

10. The method of claim 1 further comprising:
determining a position of the vehicle;
determining preferences and/or constraints for the driving mechanism for the vehicle position; and
performing one or both of the steps of:
informing the user of the vehicle of possible driving mechanism preferences or constraints, or automatically selecting the driving mechanism in accordance with the driving mechanism constraints or preferences.

11. The method of claim 10 where the step of determining the use of the different driving mechanisms includes a step of selecting a driving mechanism for which no constraint exists during a part of the route for which a driving mechanism constraint is present.

12. The method of claim 11 further comprising:
determining whether, based on the resource status, a route can be calculated meeting the driving mechanism constraints or preferences.

13. The method of claim 1 further comprising:
determining a minimum resource level for at least one of the different driving mechanisms and ensuring that the resource status for the at least one driving mechanism does not fall under the minimum resource level during the step determining the use of the different driving mechanisms.

14. The method of claim 1 further comprising:
predicting the resource status for the different parts of the route, where during driving, the resource status is determined to differ from the predicted resource status by a predetermined amount.

15. The method of claim 14 where the step of determining the use of the different driving mechanisms is recalculated for a remainder of the route if the resource status differs from the predicted resource status by a predetermined amount.

16. The method of claim 15 where the step of determining the use of the different driving mechanisms includes the step of determining at least one switch location for changing the driving mechanism, where the at least one switch location is repeated for a remainder of the route if the resource status differs from the predicted resource status by a predetermined amount.

17. The method of claim 14 further comprising:
determining the driver's driving habits relative to the resource consumption, and accounting for the driver's driving habits during the step of predicting the resource status for the different parts of the route.

18. The method of claim 1 further comprising:
determining traffic information for the determined route; and
accounting for the traffic information during the step of determining the use of the driving mechanisms for the determined route.

19. The method of claim 1 further comprising:
determining a preset condition where the step of determining the route includes calculating the predetermined destination location in accordance with the preset condition.

20. The method of claim 1 further comprising:
determining whether the destination location includes a refilling location for refilling a resource for at least one of the driving mechanisms where the step of determining the route and the step of determining the use of the different driving mechanisms includes accounting for the refilling location.

21. The method of claim 1 where the different driving mechanisms includes a fossil-fuel consuming driving mechanism, and where the step of controlling the driving mechanisms includes determining the route so as to minimize the fuel consumption for a fossil fuel.

22. A method for determining a route for a hybrid vehicle, the hybrid vehicle having at least two different mechanisms for driving the vehicle, the method comprising:
determining a resource status of at least one of the at least two different driving mechanisms;
determining a destination location for the vehicle;
determining a route to the predetermined destination location based upon the determined resource status of the at least one of the at least two different driving mechanisms.

23. The method of claim 22 where the driving mechanisms are selected from the following mechanisms: gasoline, diesel, gas engine, electric motor, or hydrogen driven motor.

24. The method of claim 22 where the step of determining the resource status includes determining the resource status for a non-fossil fuel combusting driving mechanism.

25. The method of claim 22 where one driving mechanism is an electric motor and the step of determining the resource status include the step of determining a charge status of a battery that stores the electric energy for the electric motor.

27. The method of claim 22 where the step of determining a route to the predetermined destination location based upon the determined resource status of the at least one of the at least two different driving mechanisms includes accounting for driving mechanism constraints when determining the route.

28. A system for controlling a hybrid vehicle, the hybrid vehicle having at least two different driving mechanisms, the system comprising:
a resource determination unit for determining the resource status of at least one of the at least two different driving mechanisms;
a position detecting unit for calculating the present position of the vehicle;
a route determination unit for determining the route to a predetermined destination location; and
a driving mechanism control unit for determining the use of the different driving mechanisms and for determining switching locations for changing the driving mechanism for the route in accordance with the determined resource status.

29. The system of claim 28 where the hybrid vehicle has at least one of the following driving mechanisms: a fuel combustion motor, an electric motor, and hydrogen driven motor.

30. A system for controlling a hybrid vehicle, the hybrid vehicle having at least two different driving mechanisms, the system comprising:
a resource determination unit for determining the resource status of at least one of the at least two different driving mechanisms;
a position detecting unit for calculating the present position of the vehicle; and
a route determination unit for determining the route to a predetermined destination location based upon the determined resource status of the at least one of the at least two different driving mechanisms.

31. The system of claim 30 where the hybrid vehicle has at least one of the following driving mechanisms: a fuel combustion motor, an electric motor, and hydrogen driven motor.
